(19) United States
(12) Patent Application Publication
(10) Pub. No.: US 2024/0370276 A1
(43) Pub. Date: Nov. 7, 2024

(54) AUTOMATICALLY DETECTING ANOMALIES IN COMPLEX CONFIGURATIONS

(71) Applicant: Microsoft Technology Licensing, LLC, Redmond, WA (US)

(72) Inventors: Ryan Andrew BECKETT, Redmond, WA (US); Siva Kesava Reddy Kakarla, Belleview, WA (US); Yu Yan, Issaquah, WA (US)

(21) Appl. No.: 18/333,930

(22) Filed: Jun. 13, 2023

Related U.S. Application Data
(60) Provisional application No. 63/463,748, filed on May 3, 2023.

(51) Int. Cl. G06F 9/445; G06N 5/04

(52) U.S. Cl. CPC G06F 9/44505; G06N 5/04

(57) ABSTRACT

The present application relates to a system, apparatus, and method of detecting anomalies in configurations of computer systems. A computer may execute a configuration analyzer to infer a configuration template that is applicable to multiple configuration files. The configuration analyzer configuration uses unsupervised learning on the configuration template to score parameters within each configuration file. The configuration analyzer indicates an anomaly for a parameter of a configuration file exceeding a threshold score. Inferring a configuration template may include generating a lowest cost template that is applicable to two of the multiple configuration files based on a cost function; and combining the lowest cost template with a subsequent configuration file of the multiple configuration files to generate an updated lowest cost template until the updated lowest cost template is applicable to all of the multiple configuration files.

### CROSS REFERENCE TO RELATED APPLICATIONS

This application claims priority to U.S. Provisional Application No. 63/463,748 titled “AUTOMATICALLY DETECTING ANOMALIES IN COMPLEX CONFIGURATIONS,” filed May 3, 2023, which is assigned to the assignee hereof, and incorporated herein by reference in its entirety.

### BACKGROUND

As computer networks and systems have become increasingly feature-rich, so too have their configurations become commensurately more complex. From the radio access network (RAN) to layer 3 routing protocols such as border gateway protocols (BGP), all the way up to the application-layer with orchestration frameworks like Kubernetes, databases like MySQL and more; configurations play a critical role in defining and enforcing rich policies across the network stack.

The rise of configuration as the common medium for organizing networks and systems has led to a corresponding proliferation of misconfiguration-related outages when humans or automation introduce configuration errors. For instance, misconfigurations in routing protocols have led to global outages at cloud providers that host services for many enterprises. Beyond infrastructure providers, misconfigurations have also caused outages across numerous industries, including airlines, financial institutions, streaming, E-commerce services, and social media. In general, misconfigurations are reported as a leading cause (60%) for availability and performance errors for enterprises.

To combat misconfiguration, one line of research has explored the use of data-driven learning methods to identify possible errors as anomalies or deviations from the norm from a large training corpus of example configurations. This approach is appealing because the user is not required to specify what is a correct or incorrect in a configuration. In many cases such correctness specifications may be difficult to obtain, or worse, may even be unknown to the operators of the network.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus for analysis of computer configurations, including: a memory storing computer-executable instructions; and at least one processor coupled to the memory and configured to execute the instructions to: infer a configuration template that is applicable to multiple configuration files; use unsupervised learning on the configuration template to score parameters within each configuration file; and indicate an anomaly for a parameter of a configuration file exceeding a threshold score.

In some aspects, the techniques described herein relate to a method of detecting anomalies in configurations of computer systems, including: inferring a configuration template that is applicable to multiple configuration files; using unsupervised learning on the configuration template to score parameters within each configuration file; and indicating an anomaly for a parameter of a configuration file exceeding a threshold score.

In some aspects, the techniques described herein relate to a non-transitory computer-readable medium storing computer executable instructions for detecting anomalies in configurations of computer systems, the instructions, when executed by a processor, cause the processor to: infer a configuration template that is applicable to multiple configuration files; use unsupervised learning on the configuration template to score parameters within each configuration file; and indicating an anomaly for a parameter of a configuration file exceeding a threshold score.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of an architecture for a wide area network (WAN), in accordance with aspects described herein.

FIG. 2 is a conceptual diagram illustrating operation of a configuration analyzer.

FIG. 3 is a diagram of an example configuration snippet for a WAN, a template, and an output for the configuration analyzer.

FIG. 4 is a diagram of an example definition of an input and template structure.

FIG. 5 is a diagram of an example of determining a minimum cost template.

FIG. 6 is a diagram of a computation of list templates for example lists.

FIG. 7 is a chart showing a plot of the precision versus an anomaly score threshold.

FIG. 8 is a diagram of another example of configuration analyzer in use for a simplified and anonymized configuration of a 5G testbed.

FIG. 9 is a chart showing the fraction of the runtime for the subset of configurations compared to that of the full set of configurations relative to the ratio of configurations analyzed.

FIG. 10 is an example snippet of code for an example algorithm for the configuration analyzer to efficiently compute the set of matching indices for regular expression tokens against another sequence of characters and tokens.

FIG. 11 is a schematic diagram of an example of an apparatus (e.g., a computing device) for analyzing complex configurations of computer systems or networks.

FIG. 12 is a flow diagram of an example of a method for analyzing complex configurations of computer systems or networks.

FIG. 13 illustrates an example of a device including additional optional component details as those shown in FIG. 11.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to detecting anomalies in complex configurations. For example, the configurations may be for computer networks or computer systems that include multiple devices with similar configurations. In an aspect, the techniques disclosed herein are generally applicable to structured configuration as indicated by a set of configuration files. For example, the configuration files may be JavaScript object notation (JSON) files.

While a data-driven approach is appealing for analyzing complex configuration, current incarnations of data-driven learning have several major limitations. First, they apply only to simple configurations that are represented as a bag of key value pairs. While some configurations such as those for databases meet this requirement, many network configurations include richer structured policies including tabular data like ACLs and prefix lists or even complex embedded domain-specific languages such as routing policies, cloud resource permissions languages, and more. Existing tools are not applicable in these settings. Second, prior data-driven approaches often require users to incorporate domain-specific knowledge into their tools. For instance, copious configuration data is specified in strings with custom, ad hoc, or domain-specific formats. Existing tools rely on inferring basic types from these strings (e.g., a file path, an integer, an IP address or that “ON” and “OFF” are Booleans). As a result, these tools either can learn little from ad hoc string data that does not conform to the predefined types for the tool, or require the user to add domain-specific configuration knowledge to the tools.

In an aspect, the present disclosure provides a method, apparatus, and computer-readable medium for identifying anomalies in configurations. The method includes inferring a configuration template that is applicable to multiple configuration files. The method includes using unsupervised learning on the configuration template to score parameters within each configuration file. The method includes indicating an anomaly for a parameter of a configuration file exceeding a threshold score.

The anomalies may be likely bugs in arbitrary structured complex configurations and with ad hoc data formats. The disclosed method takes as input (i) a set of structured configuration files, for example, specified in the JSON format (i.e., configurations with arbitrarily nested objects and lists) as well as (ii) a set of lightweight regular expression patterns. These patterns are simple (e.g., what is a number, hex value, or lower case letter) and portable across domains. From these inputs the system produces a configuration template, which captures the common and distinct patterns across the configurations. While many such templates may exist, the system efficiently produces a low-cost template (i.e., a compact template matching the inputs).

The system uses a novel dynamic programming algorithm to infer templates for strings with ad hoc or domain-specific data formats. This algorithm efficiently learns the set of lowest cost patterns matching a group of strings, and scales to thousands of configurations through an incremental inference technique. The technique updates the set of learned patterns greedily with respect to a new string and retroactively improves those patterns on the fly. Although a single string inference can have worst case complexity of O(m2·n2) for two strings of size m and n, several optimizations make the problem highly scalable in practice.

The system efficiently generates templates for structured data, including nested lists and objects, by recursively evaluating element templating costs and selecting the most suitable template type, such as ordered, unordered, or repetitive. This approach allows the system to handle arbitrarily nested structures including lists of lists, lists of objects, and more. Finally, using the inferred template, the system employs state-of-the-art unsupervised machine learning methods to identify probable bugs as anomalous template parameters.

The system may be applied to various configurations such as configuration of a large wide-area network for a cloud provider, an operational 5G testbed, and MySQL database configurations mined from GitHub. The system generalizes across domains as an automatic, domain-agnostic bug finder applicable to such diverse network configurations. The system scales well, analyzing hundreds to thousands of configurations within seconds to a few minutes, exhibits a near-linear scaling trend, and outperforms state-of-the-art data mining tools by 2-3 orders of magnitude. The system achieves high precision (e.g., up to 97% on the wide-area network) and identifies issues comparable to domain-specialized tools.

Implementations of the present disclosure may provide one or more of the following technical benefits. Identification of anomalies within configuration files may avoid erroneous configurations that lead to network downtime. The techniques disclosed herein improve the performance of the network by preventing network downtime. Additionally, use of machine learning for both template learning and anomaly detection avoids needs for user specification of correct templates and reduces manual review of configurations. Accordingly, the disclosed techniques improve the interface between a user and a tool for identifying configuration errors. Further, learning templates based on complete configuration files allows the techniques and tools to apply to any type of structured configuration, expanding the availability and use of the tool.

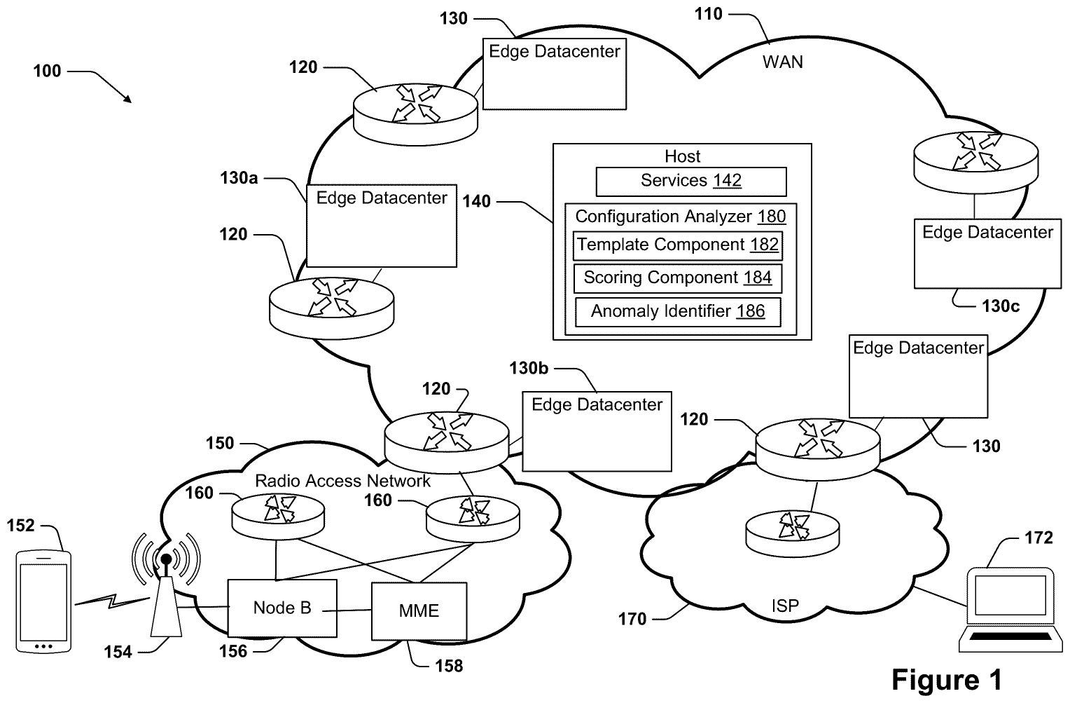

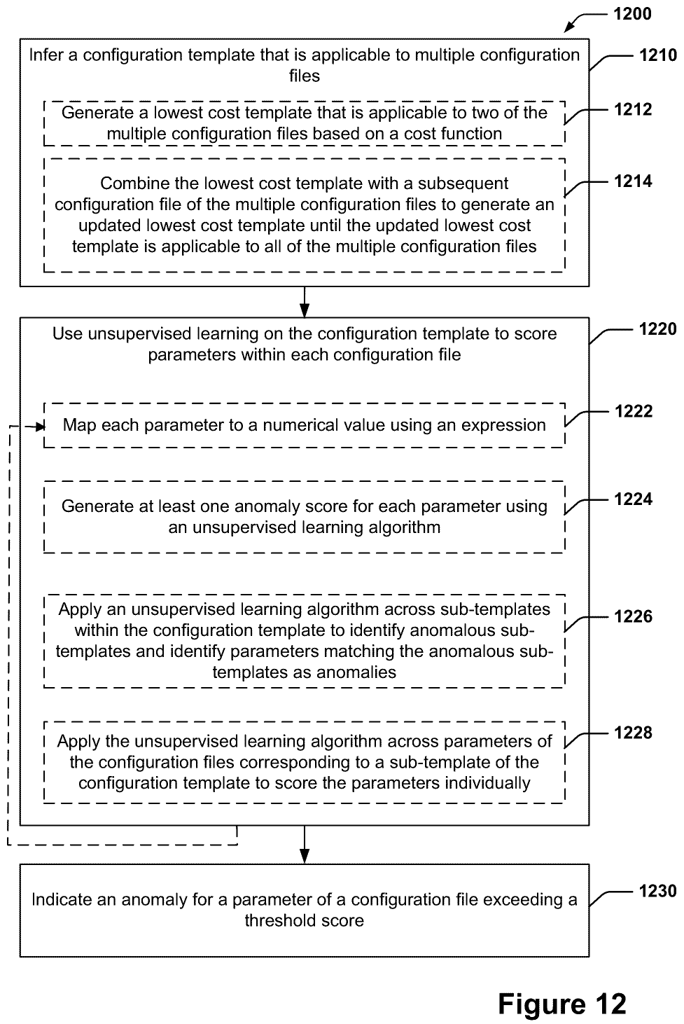

Turning now to FIGS. 1-13, examples are depicted with reference to one or more components and one or more methods that may perform the actions or operations described herein, where components and/or actions/operations in dashed line may be optional. Although the operations described below in FIG. 12 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and a software component capable of performing the described actions or functions.

FIG. 1 is a conceptual diagram 100 of an example of an architecture for a wide area network (WAN) that includes complex configurations. The WAN 110 may include computing resources that are controlled by a network operator and accessible to enterprise clients. For example, the WAN 110 may include a plurality of hosts 140 that host services 142. Each host 140 may be, for example, a virtual machine on a computing resource such as a server including memory and processors located in a datacenter. The WAN 110 may include routers 120 such as edge routers that connect the hosts 140 to external networks such as internet service providers (ISPs) 152 or other ASes that form the Internet. In some implementations, a router 120 at an edge of the WAN 110 may be referred to as a point of presence (POP). A POP may refer to a location where an edge router is directly connected (e.g., via a fiber optic cable) to routers of other networks. In an implementations, the WAN 110 may include edge datacenters 130 (e.g., edge datacenters 130a, 130b, and 130c) that include computing resources located adjacent to an edge router. For instance, an edge datacenter 130 may be directly connected (e.g., via a fiber optic cable) to a corresponding edge router 120. The WAN 110 may host various services and may be referred to as a cloud network or cloud service provider.

The WAN 110 may be connected to one or more other communications networks such as a radio access network (RAN) 150 or an internet service provider 170. The RAN 150 may be, for example, a virtualized radio access network (RAN), although the concepts described herein are applicable to other communications networks. In some implementations, the RAN 150 may be a fourth generation (4G) network, fifth generation (5G) network, or beyond. These example RANs are part of a continuous mobile broadband evolution promulgated by Third Generation Partnership Project (3GPP) to meet new requirements associated with latency, reliability, security, scalability (e.g., with Internet of Things (IoT)), and other requirements. The RAN 150 may provide access for user equipment (UEs) 152. The RAN 150 may include radio units 154, a base station such as a node B 156, a mobility management entity (MME) 158, and one or more routers 160. In some implementations, the

The radio units 154 may include antennas configured to transmit and/or receive radio frequency (RF) signals. In some implementations, the radio units 154 may include RF processing circuitry. For example, the radio units (RUs) 154 may be configured to convert the received RF signals to baseband samples and/or convert baseband samples to RF signals. The RUs 154 may be connected to a node B 156, which may a dedicated hardware device or a virtualized device implemented on a datacenter. The node B 156 may perform specific RAN protocol stacks including, for example, physical (PHY) layer, media access control (MAC) layer protocol stacks, radio link control (RLC) layer, and a radio resource control (RRC) layer. The MME 158 may control mobility of a UE 152 between RUs 154 and/or node Bs 156. For example, the MME 158 may forward session information between node Bs. 156 when a UE 152 is handed over.

In some implementations, the RAN 150 may be connected to or include a core network. In some implementations, the WAN 110 may implement virtual nodes corresponding to the nodes of the RAN 150 or the core network. The core network may perform higher layer network functions. For example, the core network may instantiate network functions such as one or more Access and Mobility Management Functions (AMFs), a Session Management Function (SMF), and a User Plane Function (UPF). These network functions may provide for management of connectivity of the UE 152. For example, the UPF may provide processing of user traffic to and from the Internet. For instance, a UPF may receive user traffic packets and forward the packets to a server (e.g., a datacenter 130) via one or more routers 160.

The ISP 170 may be a communications network that connects user devices 172 to the Internet. In some implementations, an ISP may be connected with the WAN 110 at a POP.

The WAN 110 and connected communications networks may include numerous configurations. In an aspect, the WAN 110 implements a configuration analyzer 180. The configuration analyzer 180 is configured to identify anomalies in configuration files for various computer networks or systems. For example, the configuration analyzer 180 may analyze configuration files for the WAN 110. For instance, each of the routers 120 may have a similar configuration for routing both ingress and egress traffic. Similarly, where the WAN 110 provides virtual nodes for the RAN 150, the WAN 110 may include configurations for each RAN node that are generally similar. As discussed in further detail below, the configuration analyzer 180 automatically infers templates from multiple configuration files, uses unsupervised learning to score configurations, and identifies parameters that differ from the other configuration files as anomalies. In some implementations, the configuration analyzer 180 includes a template component 182 configured to infer a configuration template that is applicable to multiple configuration files. The configuration analyzer 180 includes a scoring component 184 configured to use unsupervised learning on the configuration template to score parameters within each configuration file. The configuration analyzer includes an anomaly identifier 186 configured to indicate an anomaly for a parameter of a configuration file exceeding a threshold score.

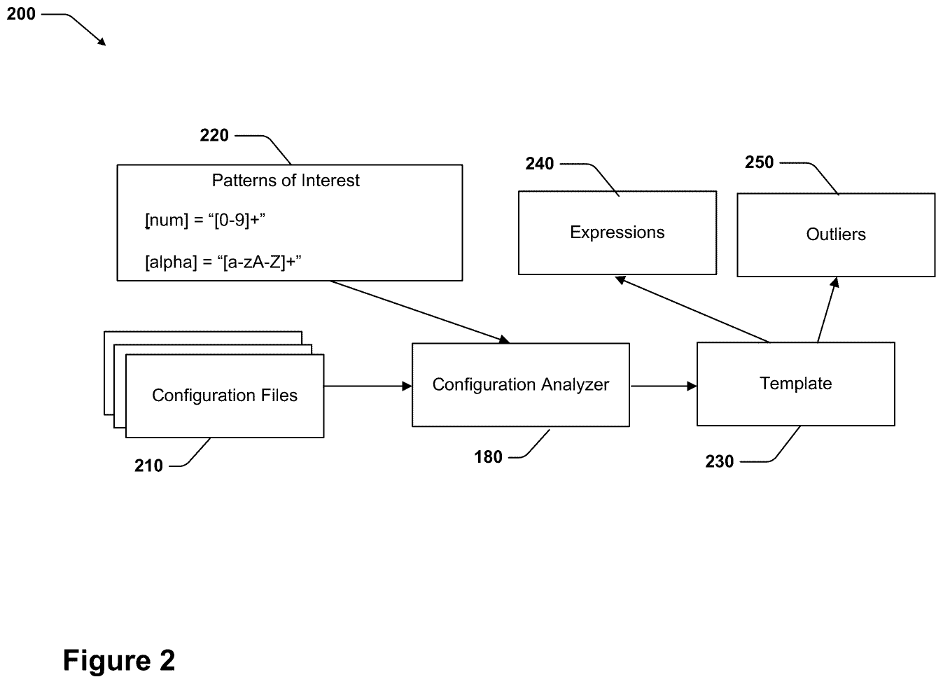

FIG. 2 is a conceptual diagram 200 illustrating operation of the configuration analyzer 180. As illustrated in FIG. 2, the configuration analyzer 180 requires two inputs: a collection of configuration files 210 for analysis and a set of patterns of interest 220, which are short string tokens (e.g., describing numbers, lowercase letters, etc.). From these inputs, the configuration analyzer 180 closely matches the configurations to generate a template 230. This template 230 serves to succinctly summarize the parts of the configurations that either conform (i.e., expressions 240) or do not conform (i.e., outliers 250) to different patterns. By examining the distribution and number of configurations that differ in relation to these patterns, the configuration analyzer 180 identifies potential bugs as configurations with anomalous parameters.

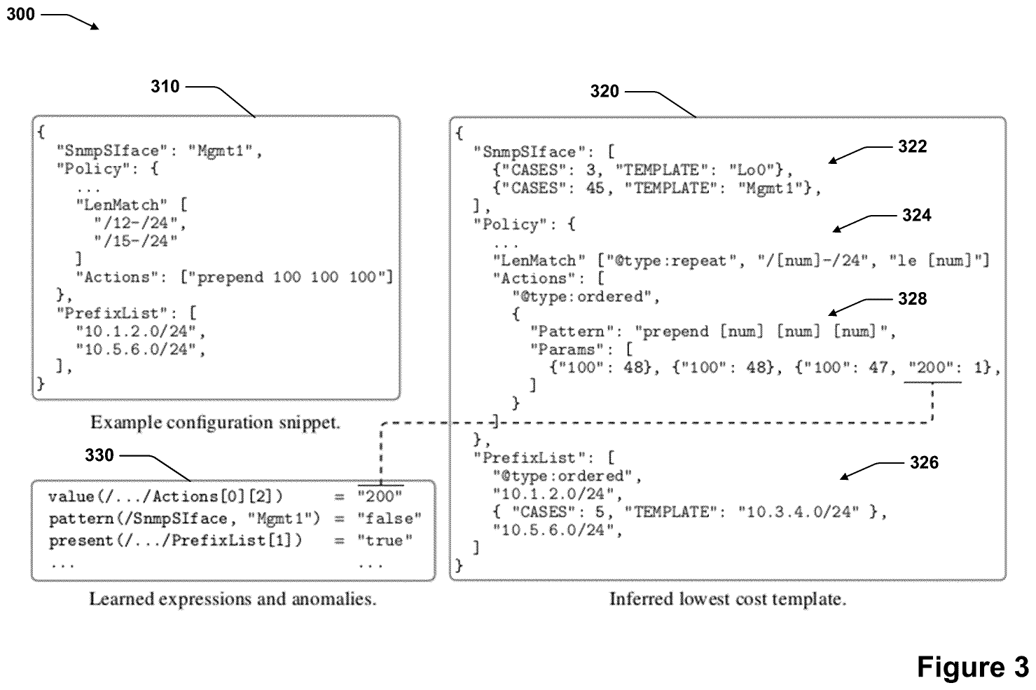

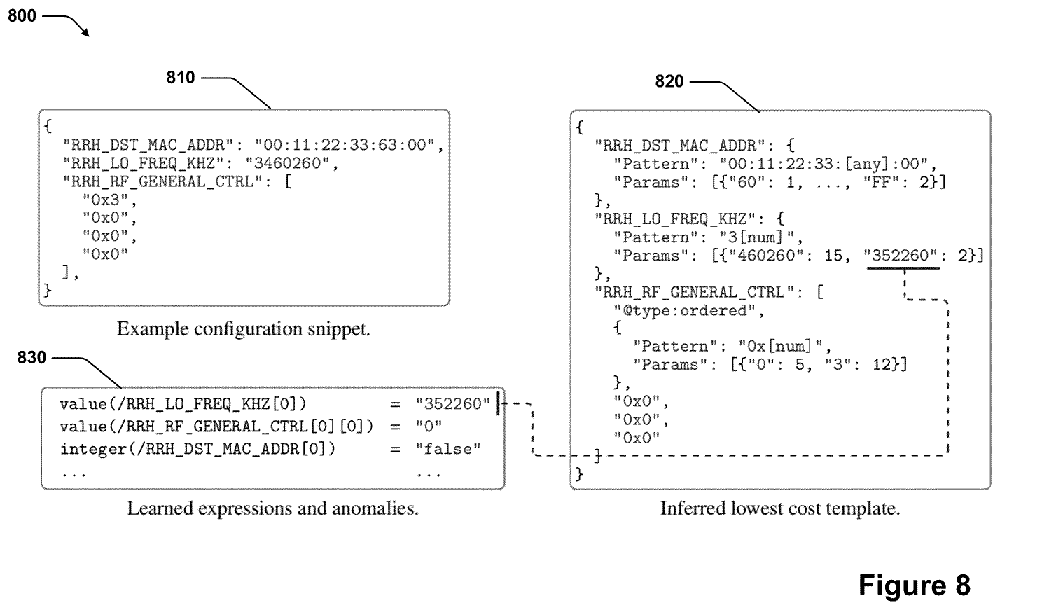

FIG. 3 is a diagram 300 of an example snippet of a configuration 310 for a WAN, a template 320, and an output 330 for the configuration analyzer 180. The diagram 300 shows an example of the output 330 of the configuration analyzer 180 for small snippets inspired by an operational wide-area network (WAN) for a large cloud provider. The snippet of configuration 310 is anonymized and modified for clarity and privacy reasons. FIG. 8 includes another example for an operational 5G testbed. Both examples use a single “number” token of [num]=“[0-9]+”. Consider the first WAN example, which has an example configuration 310 shown in the top left.

Analyzing configuration files like for this WAN poses several challenges due to its extensive use of complex structure. For example, prefix and route length filters are collections (lists) whose order, size, and specific elements may or may not matter depending on the context. Moreover, the configuration consists of nested objects with varying keys and values, some of which may be missing. Current configuration anomaly detection tools are unable to handle such configurations in their generality.

Second, an abundance of data exists in ad hoc data formats. For example, route policy actions like AS number prepending (e.g., “prepend 100 100 100”) and route length filtering (e.g., “/15-/24” and “le 16”) employ unconventional data formats that hinder existing configuration anomaly detection tools, which will learn little to nothing from strings that do not conform to a predefined set of types such as an integer, Boolcan, or file path.

In theory, it is possible to enhance these tools by incorporating specialized parsers and types tailored to specific domains. However, this would necessitate a significant investment of effort. For example, router vendors offer support for thousands of distinct configuration parameters, presented in a variety of formats. Furthermore, this process needs to be repeated for each new configuration type that one aims to analyze, thereby restricting the broad applicability of the tool.

Using a set of input configurations (e.g., configuration files 210) like the provided example configuration 310, the template component 182 infers a template 320 that concisely summarizes the configuration files 210. For the first segment of configuration 310: SNMP source interface (“SnmpSIface”), template component 182 identifies a “choice” sub-template 322 indicating that the interface value is either “Mgmt1” or “Lo0”, with the former appearing much more frequently. As there is no simpler pattern to represent these two distinct choices, they are left separate in the template 320.

For the route length filters list (“LenMatch”) in configuration 310, the template component 182 has inferred a “@type: repeat” sub-template 324 that says that all the elements of the list are well summarized as corresponding to one of two patterns: “/[num]−24” or “le [num]”. On the other hand, for the “PrefixList” component of template 320, the template component 182 has identified that the better sub-template 326 for these values is an ordered list (“@type:ordered”), which consists of “10.1.2.0/24” and “10.5.6.0/24” as well as “10.3.4.0/24”, but only for a small number of configurations.

Besides capturing succinct templates for structured data, template component 182 can also manage irregular data formats. For instance, the template component 182 learns the sub-template 328 for adding AS numbers as “prepend [num] [num] [num]”, understanding the values captured by each [num] token. This information allows the configuration analyzer 180 to identify abnormal configurations. Despite lacking prior knowledge of AS path prepending, the configuration analyzer 180 successfully extracts a helpful pattern from the data to detect outliers 250.

The scoring component 184 uses unsupervised machine learning on the template 230 to identify expressions over configuration values with anomalous characteristics. The expressions 240 are provided with example output 330 in the bottom left table of FIG. 3. For instance, the first example shows that the value of the 2nd parameter of the 0th list element in the “Actions” template being “200” is anomalous since most configurations use “100”. The second expression specifies that the “SnmpSIface” does not correspond to pattern “Mgmt1”, which is again anomalous. The anomaly identifier 186 reports all such anomalies along with an anomaly likelihood score.

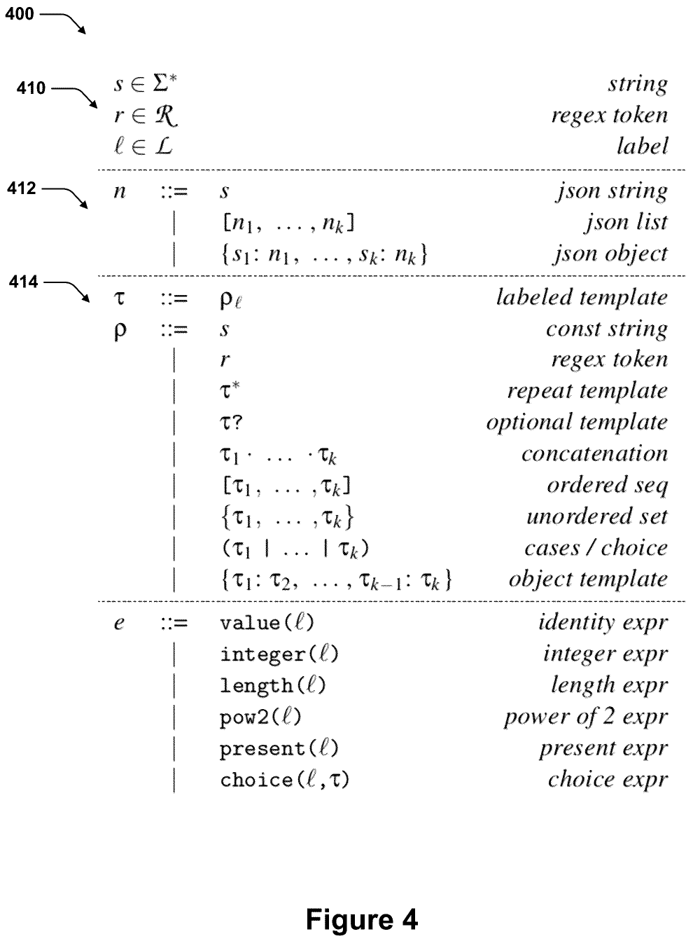

FIG. 4 is a diagram 400 of an example definition of an input and template structure referred to as a template abstract syntax tree 410. The template component 182 processes configurations in JSON format, defined by a basic grammar for a JSON node (n). Specifically, a JSON node 412 is a JSON string(s), a list of JSON nodes, or a JSON object containing unordered key-value pairs with string keys and JSON node values.

A labeled template (t) 414 includes a unique label for reference and the template itself (r). The template may be a constant string(s), regular expression token (r), or a concatenation of sub-templates (τ₁· . . . ·τₖ). For example, “/[num]-/24” is a concatenation of “/”. [num]. “-/24”. Templates for lists may be unordered sets {τ1 . . . , τₖ)}, ordered sequences [τ₁, . . . τₖ] or repetitions of a sub-template (τ*). An optional template (τ?) indicates an element that may be present or absent. Object templates consist of key-value template pairs. Finally, a choice template (τ₁| . . . |τₖ) signifies a case split, where a configuration will match any of τ₁ through τₖ, useful for representing sets of configuration that correspond to distinct patterns.

Going back to FIG. 3, the template 320 can be presented in JSON more formally in this template language. For instance, the following template represents the inferred template for the “LenMatch” field:

((“/”ₐ·[num]_{b}·“-/24”_{c})_{d}|(“le”ₑ·[num]_{f})_{g})*ₕ. That is, the field represents a sequence (list) of zero or more elements, where each element is described by a choice of either of the two patterns. As another example, consider the “Actions” field for the route policy. The inferred template is the following:
(“prepend”ₐ·[num]_{b}·“ ”_{c}·[num]_{d}·“ ”ₑ·[num]_{f})_{g}

Each sub-template in configuration analyzer 180 has a unique label, which allows for writing expressions over configuration values by referencing one or more labels. For example, the expression from FIG. 3 states that the value captured by f is unlikely to be “100”, or value(f)=“100” is an anomaly. This format also permits expressions involving multiple parameters, like value(b)>value(d), or even the entire string with g. Expressions allow for transforming configuration values in a way that reveals anomalies. For example, the values “1”, “2”, “3”, “Z” for a label x may not appear anomalous as strings, but when evaluated as integer(x), the string “Z” now appears to be an anomaly.

As a final example, the “PrefixList” field is an ordered list template where one of the fields is optional, and is expressed with the following template: [“10.1.2.0/24”ₐ, (“10.3.4.0/24”_{b})?_{c}, “10.5.6.0/24”_{d}]ₑ

The expression present(c) from FIG. 3 maps the optional value to a Boolean representing whether c is present in a configuration. Since most configurations do not include the expression labeled c, those with result “true” are flagged as anomalies. This concept is general and allows for capturing rich information. For example, the label e captures the value of the list in each configuration, which would then allow for expressions such as length(e). For simplicity and readability, the label may be elided from a template for readability, except when needed.

Multiple templates can represent a given set of configurations. The goal of the configuration analyzer 180 is to find the most suitable template that accurately describes the data without being too general or complex. For example, given the strings “abc1”, “abc2”, “abc3”, several templates could represent the strings. The token [any]=“.*” covers all three strings but is overly broad because the token captures all other strings as well. Alternatively, the template (“abc1”|“abc2”|“abc3”) includes all three strings but is narrow and complex, likely leading to overfitting. The template “abc”·[num] perhaps achieves the best balance between conciseness and specificity.

A method for inferring string templates is based on template cost. The inputs to the configuration analyzer 180 include a set of regex tokens R and a cost function C that assigns a per-character cost C₍ᵣ₎ (between 0.0 and 1.0) to each regex token. Throughout this disclosure, the token [any] belongs to R, with C([any])=1.0, ensuring a valid template always exists. A 0.0 cost represents the best fit, while a 1.0 cost signifies the worst fit. Given a string template t and a matching string s, the definition of C is extended to determine the match cost C(t, s) as the sum of the per-character costs.

$$𝒞 ( τ , s ) = \{ \begin{matrix}0. & if τ = s \\ 𝒞 ( r ) * \vert s \vert & if τ = r \\ {\sum }_{i = 1}^{k} 𝒞 ( {τ}_{i} , {s}_{i} ) & if τ = {τ}_{1} \cdot … \cdot {τ}_{k} , s = {s}_{1} \cdot … \cdot {s}_{k}\end{matrix}$$

where each τᵢ matches string sᵢ.

This definition of cost is extended to a set of configuration strings s by summing the cost of each string in the set: C(τ, s)=Σ_{s∈S}C(τ, s). For convenience, in the remainder of the disclosure, each string template t is implicitly associated with a set of strings s—namely those strings that were used to create t. The set sis elided and the expression C(τ) is used to refer to the cost of the template. The notation |t| refers to the total number of characters Σs∈S|s| associated with T. Finally, the normalized cost Ĉ(T) is defined as the average per-character cost: Ĉ(T)=C(T)/|T|.

Using the defined cost criteria, the configuration analyzer 180 identifies the most cost-effective concatenation of templates that match a set of strings S. This is achieved through a dynamic programming approach. The algorithm accepts two string templates as input and produces the lowest-cost template that matches all strings from both inputs. The algorithm begins by templating the initial two strings in S and iteratively combines the resulting template with subsequent strings until all have been processed.

For simplicity, it is assumed that all constant string templates are of size 1 (e.g., “10” is represented as “1”·“0”) and that there are no nested concatenations since these are flattened into a single concatenation. If the first string template is given as the concatenation τ₁¹ . . . τₘ¹ and the second template is τ₁² . . . τₙ², then the lowest cost result template for τ₁¹ . . . τᵢ¹ and τ₁² . . . τⱼ² is defined as the match cost M(i, j) as follows:

$$( i , j ) = min \{ \begin{matrix}0. & if i , j = 0 \\ ( i - 1 , j - 1 ) + 𝒞 ( {τ}_{i}^{1} ) + 𝒞 ( {τ}_{j}^{2} ) & if {τ}_{i}^{1} = {τ}_{j}^{2} \\ ( i , b - 1 ) + 𝒞 ( r ) \cdot \vert {τ}_{b}^{2} {⋯τ}_{j}^{2} \vert & \\ if r ∈ ℛ , ″″ ∈ ℒ ( r ) , b ∈ I ( r , {τ}_{1}^{2} {⋯τ}_{j}^{2} ) & \\ ( a - 1 , j ) + 𝒞 ( r ) \cdot \vert {τ}_{a}^{1} {⋯τ}_{i}^{1} \vert & \\ if r ∈ ℛ , ″″ ∈ ℒ ( r ) , a ∈ I ( r , {τ}_{1}^{1} {⋯τ}_{i}^{1} ) & \\ ( a - 1 , b - 1 ) + 𝒞 ( r ) \cdot ( \vert {τ}_{a}^{1} {⋯τ}_{i}^{1} \vert + \vert {τ}_{b}^{2} {⋯τ}_{j}^{2} \vert ) & \\ if r ∈ ℛ , a ∈ I ( r , {τ}_{1}^{1} {⋯τ}_{i}^{1} ) , b ∈ I ( r , {τ}_{1}^{2} {⋯τ}_{j}^{2} ) & \end{matrix}$$

The minimum cost template for inputs is M(m, n). Initially, the cost is 0.0. The cost is then computed recursively in two scenarios. In the first case, both sequences have the same next template, and the previous cost, M(i−1, j−1), is updated by the costs of the matched i^{th} and j^{th} templates. The second scenario includes three cases that involve a “backwards jump” using regex tokens such as [num] or [any]. For each token r∈ [symbol] , all indices a and b that match strings τₐ¹ . . . τᵢ¹ and τ_{b}² . . . τⱼ² with r are considered. This logic is represented by an index match function. This logic is abstracted behind the term I, which is implemented by tracking automaton states for each regular expression. In the last case, there is a diagonal jump, and the lowest cost is updated from M(a−1,b−1) by adding the regex cost C(r) for each character matched by the regex. If token r matches an empty string i.e., “ ” is in the language, L(r), we can also jump backwards only in horizontal (1^{st} case) or vertical direction (2nd case), matching on only one input template. [any] is an example of such token.

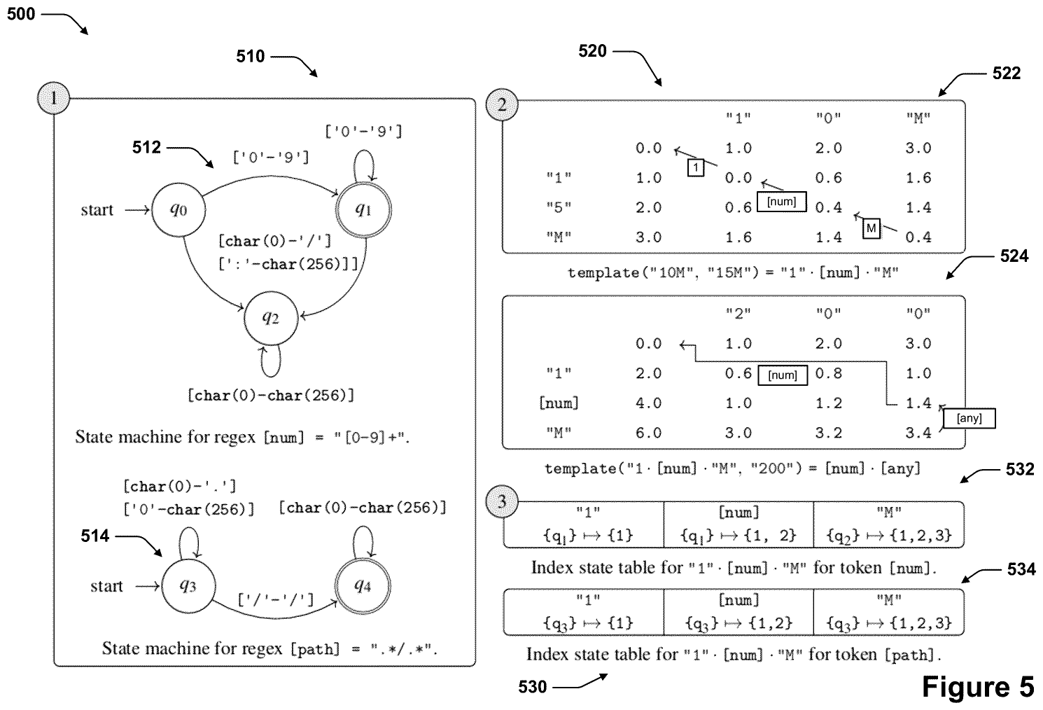

FIG. 5 is a diagram 500 of an example of determining a minimum cost template. The algorithm has three steps: 1) constructing finite state machines 510 (FSM) for each token, 2) inferring an optimal pattern using a dynamic programming table 520, and 3) tracking automaton states in separate index tables 530. The entries in the dynamic programming tables 520 can either have an exact match with zero cost or jump backward by matching a regex token.

As an example, the template component 182 determines a least cost template matching configuration strings for memory sizes: “10M”, “15M”, and “200”. The template component 182 uses two tokens, [num] and [path], both with C (r)=0.2. The template component 182 first computes the minimum cost template for (“1”·“0”·“M”) and (“1”·“5”·“M”). A dynamic programming table 522 memorizes C(i, j) values. By retracing the table 522 from the bottom right corner to the top left corner (i=0, j=0) and identifying the lowest cost case at each step, the template component 182 retrieves the lowest cost pattern.

In this case, the template component 182 obtains the template “1”·[num]·“M”. The template component 182 repeats the process with (“1”·[num]·“M”) and (“2”·“0”·“0”), and displays the dynamic programming table 524. Unlike before, the first characters do not match, necessitating a regex match. With [num] matching both characters, a valid diagonal move with cost 0.6 is possible, considering the cost C([num]) for the matched characters “1” and “2”. Moving forward, the lowest cost template involves a “backwards jump” from (2, 3) to (0, 0) using the [num] token, which matches both “200” and “1”·[num]. Lastly, the template component 182 uses an [any] token to match the final “M” template without consuming any characters from “200”, resulting in the template [num]·[any], where [num] captures the integer value of the memory size and [any] captures the optional memory units (e.g., megabytes).

In FIG. 5, the state index table 530 demonstrates the calculation of I. After templating two strings, the template component 182 obtains a template containing tokens, such as a first token “1”·[num]·“M” from template (“10M”, “15M”), as shown in the figure. To template with a third string. “200”, the configuration analyzer 180 determines the index pairs match function I. During the dynamic programming algorithm, the configuration analyzer 180 knows, for instance, that “1”·[num] matches [num] since I([num], “1”·[num])={1, 2}. In other words, starting at index 1, “1”·[num] will also be a [num] and the same trivially from index 2 (i.e., [num] will match a [num]). On the other hand, when calculating I for the entire substring for token [num], I([num], “1”·[num]·“M”)={ } since anything ending with “M” cannot be a number.

To determine if one pattern subsumes another, to the template component 182 checks if the language of one regular expression is a subset of the language of the other. For example, to check if there is a match between the 0^{th} and 1^{st} indices, the template component 182 checks if the substring “1”·[num] matches the pattern [num]. One could do this by constructing an automaton and checking for containment (e.g., L(“1”·[num])⊆L([num])). However, this approach is too slow in practice because the template component 182 calculates/for every regex r and for every pair of indices, resulting in O(m²+n²) language containment checks.

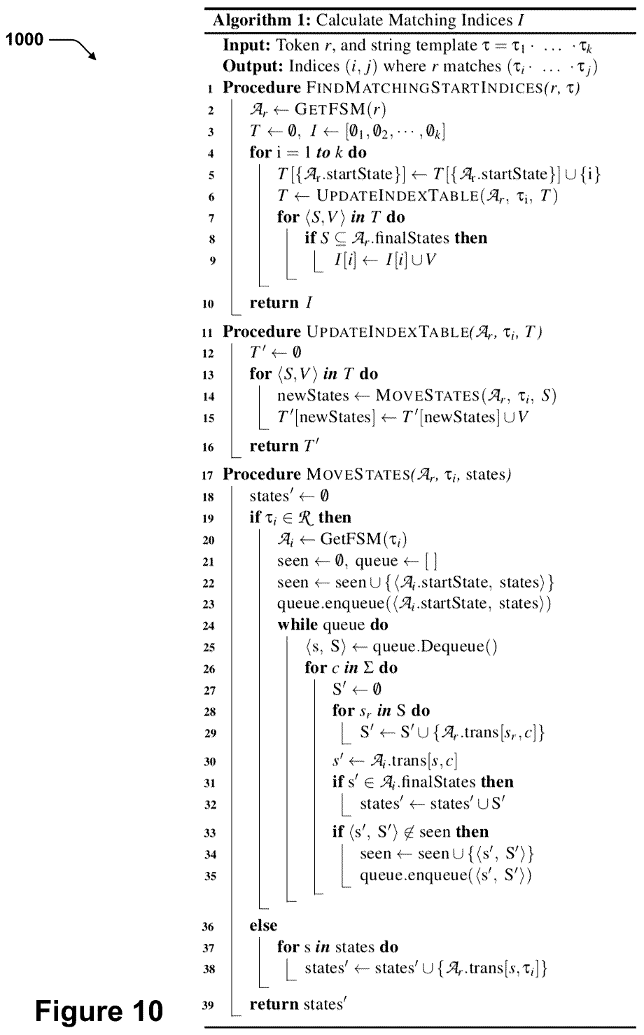

The template component 182 efficiently computes all starting indices in/by tracking potential automaton states for each starting index in the input sequence of the index state table 530. Using the example first template “1”·[num]·“M”, the set of states for each ending index is shown in finite state machine 512. The algorithm begins at state q0 of the [num] token finite state machine 512 and transitions to state q1 after processing the “1” template. The index 0 must be in state q1 when ending at the “1”, and since this is an accepting state, “1” matches [num]. As another example, an entry in an index table 530, such as entry 534 {q₃}→{0,1} at [num] for token [path], signifies that the substring starting at index 0 or 1 and ending at [num] leads to {q₃} in the finite state machine 514 of [path], which is not a final state, thus not matching both substrings. The final path determines the learned pattern. In this case, the template component 182 first learns the pattern “1”·[num]·“M” before adjusting it to [num]·[any] for the third string. Comprehensive details are described with respect to FIG. 10. This method enables near-linear time computation of all regex matches in practice.

In the above description, it was assumed that the template component 182 always returns a single template. However, if the cost of that template becomes too high, it is often better to split the template up into a choice of several templates that have much lower cost. In particular, if the normalized template cost exceeds a threshold (0.5 by default) then the template component 182 forks off the next string into its own group. When templating new strings, the template component 182 compares the new string to all the existing choices and selects the one with lowest cost to add the new string to.

For example, considering the strings “true”, “false”, and “True”, naive templating produces the template [any]·“e”, resulting in a high normalized cost. Instead, when templating “true” and “false”, if the normalized cost exceeds 0.5, the strings remain separate. Comparing “True” to both “true” and “false”, the former offers a better match with [any]·“rue”. Thus, the final template is ([any]·“rue”|“false”)

To infer a template for a set of lists, the configuration analyzer 180 recursively templates pairs of list elements. There are three template types: ordered list [T1, . . . , Tic], unordered list {T1, . . . , Tic}, and repetition T*. Configuration analyzer 180 calculates the best template for each type and selects the one with the lowest cost.

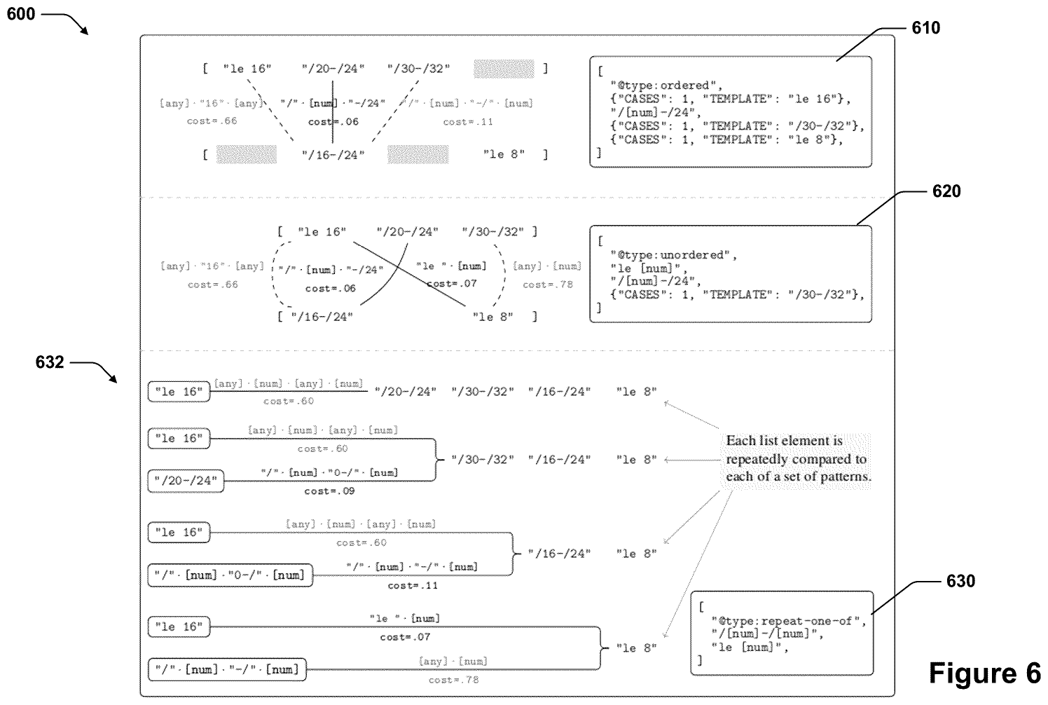

FIG. 6 is a diagram 600 of a computation of list templates for each of an ordered type, unordered type, and repeat type. The diagram 600 uses example lists: [“le 16”, “/20-/24”, “/30-/32”] and [“/16-/24”, “le 8”].

To find the best ordered template 610, the template component 182 adapts a modified sequence alignment algorithm to efficiently arrange list elements. The algorithm is designed for arbitrary lists. The template component 182 computes pair-wise templates for every element in both lists and selects the lowest-cost alignment to form a new template. For unaligned elements, an optional template indicates possible missing items. The example's resulting alignment shown in Table 1.

TABLE 1

| | | | |
|---|---|---|---|
| [ “le 16” | “/20—/24” | “/30—/32 | — ] |
| [ — | “/16—/24” | — | “le 8” |
| [“le 16”? | “/”•[num]•“—/24” | “/30—/32”? | “le 8”? |

To determine the optimal unordered template 620, the template component 182 calculates the pairwise template cost of list elements and seeks the minimum cost matching between them, provided their cost falls below the cutoff threshold. The resulting unordered template for the example is: {“le” · [num], “/”. [num]. “-/24”, “/30-/32”?}. This unordered template 620 is a marginally better match than the ordered template 610, as the “le”. [num] pattern captures multiple matches.

To deduce the optimal repeat template 630, the template component 182 merges elements from each list and applies a greedy clustering algorithm 632 as depicted in FIG. 6 (bottom). The algorithm 632 starts by creating a group with the first element (“le 16”).

Then, it compares the next element (“/20-/24”) to the group using a new template. Due to the high cost, “/20-/24” forms a separate group. The process continues with the subsequent element “/30-/32”, comparing it against both groups. It has a significantly lower cost when combined with “/20-/24”, so the configuration analyzer 180 updates the second group to be “/”·[num]·“0-/”·[num]. The algorithm proceeds until there are no elements are remaining, resulting in the final repeat template 630 of (“le”·[num]|“/”. [num]·“-”·[num]*.

The template component 182 uses a cost metric for list templates to compare the list templates and use the list templates recursively for nested structures. For example, the most cost-effective template for [[“a”, “b”], [“c”]] and [[“c”], [“b”, “a”]] is {[“c”], {“a”, “b”}}. This requires the template component 182 to recognize for the inner list that the unordered template {“a”, “b”} as having a lower cost than the alternative ordered template [“a”?, “b”, “a”?].

Given templates τ₁, . . . , τₖ, which represent ordered, unordered, repeat, or choice templates, the number of configurations matching each τᵢ is represented as μ(τᵢ) and the total number of configurations is M. The benefit of each τᵢ is defined as:

$$B ( t ) = ( 1 - C ( t ) ) \cdot \frac{μ ( τ )}{M}$$

In other words, the benefit of τ is inversely related to its cost and scaled by the fraction of matching configurations. The overall benefit for a list template is calculated as the sum of individual template benefits divided by the total template count, with the cost being the reciprocal. To account for different template types (ordered, unordered, repeat), assuming that the minimum and maximum possible number of templates for k are (λ, γ), the benefit is then normalized based on the proximity to the most compact template:

$$𝒞 ( {τ}_{1} , … , {τ}_{k} ) = 1 - ( \frac{{\sum }_{i = 1}^{k} ℬ ( {τ}_{i} )}{k} \cdot ( 1 - k - \frac{k - λ}{γ - λ} ) )$$

For example, the benefit of various templates may be considered for each of the list templates from FIG. 6. The ordered template [“le 16”?, “/”·[num]·“-/24”, “/30-/32”, “le 8”?] has benefit (1-0)·½ for the first and last two elements, and (1-0.06)·2/2 for the second element. The average benefit is 0.61. The minimum size list template for this example λ=3 since there is a list with at least 3 elements, and the maximum size γ=5 is the total number of elements, if no elements were aligned. Thus the final cost is

$$1 - 0.61 \cdot ( 1 - \frac{4 - 3}{5 - 3} ) = 0.7 ,$$

which is high.

Now consider the case for the repeat template (“le”·[num]“/”·[num]·“-”·[num])*. In this case there are two repeat templates. The first has benefit

$$( 1 - \text{.07} ) \cdot \frac{2}{2} = 0.93$$

and the second has

$$( 1 - \text{.11} ) \cdot \frac{2}{2} = 0.89 .$$

The average benefit is 0.91. The minimum template size for a repeat template is λ=1 since one pattern could capture every value, and the maximum size is γ=5 since there could be one pattern per element. Thus the final cost is

$$( 1 - 0.91 \cdot ( 1 - \frac{2 < 1}{5 - 1} ) ) = 0.31 .$$

Accordingly, in this case, the repeat template may be selected.

Handling objects is generally simpler than handling lists, as there is only one object type {τ₁:τ₂, . . . , τₖ₋₁:τₖ} and JSON object keys are always strings. To find a template, the template component 182 identifies common keys across objects for different configurations and recursively templates their values. When keys are present in some configurations but not others, the template component 182 uses an optional τ? template for the key. For example, the template of objects {“address”: “192.13.4.1”} and {“address”: “192.13.4.2”, “len”: “24”} is computed as: {“address”: “192.13.4.”·[num], “len”?: “24”?}. While this approach typically works well, the template component 182 also offers a fuzzy key matching mode for templating different keys together. This method resembles unordered template inference for keys. For example, the template for {“10.0.0.1”: “10”} and {“10.0.0.2”: “10”} would be {“10.0.0.”·[num]: “10”}.

In certain scenarios, configurations can possess distinct node types. A key might have a string value in one configuration and a list in another. The template component 182 segregates the configurations based on their types and templates them individually. The outcome is presented as a choice template, such as (τₛ|τₗ) for string and list templates.

After inferring a configuration template, the configuration analyzer 180 seeks to identify potential bugs using the scoring component 184 to find parts of the configurations that are anomalous. For example, the scoring component 184 may use a state-of-the-art unsupervised clustering technique based on isolation forests to identify anomalies. Isolation forests are efficient ensemble learning models that take into account both the density and distance of nearby points when discovering anomalies. Isolation forests assume anomalies are few and different, and thus, should be easier to separate from other samples. Isolation forests partition data randomly and recursively and calculate the (average) number of partitions required to isolate a sample as its anomaly score. To account for randomness, the approach uses many randomly partitioned isolation trees, which form a forest. Isolation forests are (1) memory-efficient (2) computationally efficient (with expected linear time complexity), and (3) do not require anomaly labels from users.

Isolation forests require inputs in the form of multidimensional numerical data. For each template label, the scoring component 184 translates the values from different configurations for that parameter into numerical data in the following steps: (1) apply each type of applicable expression (e.g., integer) to get string values, (2) if all the strings are numerical, then encode them directly, otherwise sort the strings and then apply a defined ordinal encoding to get a numerical representation. Table 2 showcases some example expressions defining ordinal encodings that the scoring component 184 may use for datasets. Users of the configuration analyzer 180 can extend the scoring component 184 to add additional expressions.

TABLE 2

| Expression | Description | Examples |
|---|---|---|
| present(x) | Optional value x has a value. | “true” |
| value(x) | The value of x. | “1.3”, “abc” |
| pow2(x) | Is value x a power of 2. | “false” |
| integer(x) | Is value x an integer. | “true” |
| choice(x, τ) | Does value x match choice τ. | “false” |
| length(x) | Length of list x. | “7”, “12” |

For example, considering a configuration parameter x with values across configurations: “2”, “4”, “8”, and “10”. The expression value (x) just returns x, and the scoring component 184 translates the values directly as [2, 4, 8, 10] leading to low anomaly scores since all values are close to each other. However, the expression pow2(x) maps the inputs to “true”, “true”, “true”, “false”, which the scoring component 184 then encodes as [1, 1, 1, 0], resulting in “10” having a higher anomaly score. Considering another parameter y for list values with values [“0x3”, “0x0”, “0x0”], [“0x0”, “0x0”, “0x0”], and [“0x0”]. The expression length(y) maps the lists to their lengths as [3, 3, 1], which may indicate the last list to be an outlier if there is sufficient evidence that most lists are longer.

The anomaly identifier 186 is configured to identify anomalies for a configuration file based on a threshold score. For example, the anomaly identifier 186 may compare the score for each parameter to a configured score threshold. The anomaly identifier 186 may then output the parameters in a configuration file that exceed the score threshold.

In an implementation, the configuration analyzer 180 may be programmed in F# code. The configuration analyzer 180 accepts a file directory with JSON configuration files and a set of tokens with associated costs, for example, through a command line or other user interface. The output from the anomaly identifier 186 includes a template, and a set of probable bugs. To enhance scalability, the configuration analyzer 180 employs several practical optimizations.

Firstly, while creating the JSON abstract syntax tree 410 from FIG. 4 in memory, the configuration analyzer 180 calculates a perfect hash for each node and stores it. This enables quick approximate equality checks between JSON elements. Utilizing this, the configuration analyzer 180 efficiently caches calls to the template component 182 to prevent redundant inferences. Furthermore, when templating sets of strings S or lists L etc., the template component 182 identifies duplicate values between configurations using hashes, and replaces the duplicate value with a single copy of the hash. This simplification applies recursively and significantly reduces the cost of templating.

Secondly, the configuration analyzer 180 caches state transitions for index tables 530 from FIG. 5. When updating states upon encountering a new token, the cache stores the new set of states as a function of the current state set, token, and new token. This drastically reduces overhead from tracking automata states, as only a small number of state sets are typically visited.

Lastly, the template component 182 omits the computation of certain list templates if their cost cannot outperform the existing ones. For instance, when the cost of an ordered template is low enough that an unordered template would never surpass it, the template component 182 refrains from calculating the unordered template.

### WAN Example

In an example, the configuration analyzer 180 was used to analyze one of the world's largest backbone networks, a wide area network (WAN) consisting of thousands of routers and millions of configuration lines. Routers in the WAN are categorized by roles, such as edge, border, core, and reflector. Table 3 shows the total number of lines of configuration for each role in the WAN. The configuration analyzer 180 was applied to each role since configurations within a role share similar definitions, like prefix lists, route policies, and community lists, though specifics can vary across routers.

TABLE 3

| | Config | Prefix list | | | Route policy | | | Other | | |
|---|---|---|---|---|---|---|---|---|---|---|
| Role | line count | P | T | A | P | T | A | P | T | A |
| R1 | [symbol] (10⁶) | 45 | 34/110 | 1.20/0.60 | 42 | 1120/1212 | 3.99/2.80 | 70 | 43/58 | 4/1.8 |
| R2 | [symbol] (10⁶) | 34 | 12/24 | 0.70/0.12 | 27 | 496/537 | 0.18/0.10 | 26 | 45/115 | 0.6/0.56 |
| R3 | [symbol] (10⁶) | 58 | 29/80 | 1.20/0.50 | 45 | 1120/1284 | 1.28/1.60 | 85 | 36/55 | 1.2/0.99 |
| R4 | [symbol] (10⁵) | 4 | 3.5/8 | 0.20/0.10 | 4 | 21/34 | 0.16/0.18 | 5 | 1.8/3.3 | 0.1/0.1 |
| R5 | [symbol] (10⁴) | 0.4 | 1/2.4 | 0.02/0.02 | 0.4 | 0.81/1.1 | 0.02/0.03 | 0.7 | 0.23/0.27 | 0.04/0.03 |

In the WAN, running router configuration files are stored in a centralized database, providing an accurate snapshot for the configuration analyzer 180. A set of golden configurations for the expected ground truth of the WAN are also available. The WAN uses a custom “diffing” service that periodically compares the golden and running configurations, reporting all current drifts that need repair. Thus, the ground truth is accessible for comparison with the configuration analyzer 180.

To convert vendor-specific configuration files to JSON, two parsers were applied: Batfish and an internal WAN parser. The latter was employed for prefix lists and route policies, while Batfish handled the remaining configurations (e.g., community lists, AS path lists, VRFs, SNMP servers, etc.). Batfish offers broader coverage but also complicates and obscures the original configuration data by expanding and inlining prefix lists and route policies. The internal parser produces JSON representations of prefix lists and route policies, as exemplified in the example configuration 310 (FIG. 3). Using these parsers, the configuration analyzer 180 analyzed over 99% of the configuration lines in the WAN.

Table 3 displays the time taken (in seconds) by the configuration analyzer 180 to transform the JSON configuration files into internal data structures (P), create templates (T), and find anomalies (A) for each role and configuration element type. The T and A times include both with and without tokens. During the learning phase, the configuration analyzer 180 reported all potential anomalies, which were then sorted and filtered by score for operator review.

In most instances, the configuration analyzer 180 completes rapidly within seconds or minutes, even when processing millions of configuration lines. Route policies, being the most complex element in routers, take the longest time. However, even in the worst-case scenarios, the configuration analyzer 180 completes route policy analysis in approximately 20 minutes.

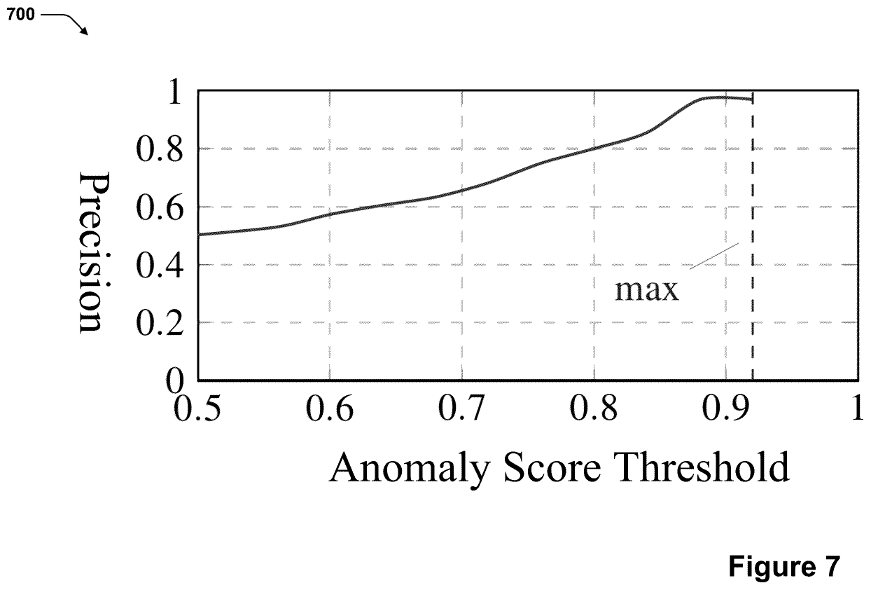

FIG. 7 is a chart 700 showing a plot of the precision (true vs. false positive ratio) of configuration analyzer 180 as a function of the anomaly score using the golden configurations as ground truth. The configuration analyzer 180 was run on each configuration role using a minimum anomaly score filter 0.51 (e.g., score threshold) to find all issues with some evidence of being an anomaly. For each router and configuration element name (Router, Name) the anomaly identifier 186 reported if the configuration analyzer 180 found an anomaly with the element for this router. The results were compared to the results reported by the “diffing” tool based on golden configurations. The anomaly score is almost perfectly correlated with its precision against the “diffing” service, indicating that the results of the configuration analyzer 180 are accurate. For instance, for issues with an anomaly score of 0.8 or higher, roughly 80% of findings reported by the configuration analyzer 180 are confirmed as true positives, and the precision goes up to 97% true positives with a threshold anomaly score of 0.88.

While ground truth exists for route policies and prefix lists, other configuration elements such as SNMP servers are not currently tracked by the diffing tool. For these policies and prefix lists, a small subset of classes of issues that the configuration analyzer 180 reported with high score were identified and manually investigated with the help of the WAN network operators. Of these, the operators identified 77% as true positives, 8% as false positives, and 15% as requiring further investigation. Many of the issues represented cruft (i.e., leftover elements) in the configurations from legacy devices and were subsequently addressed by the operators.

Table 4 shows the frequency of each type of anomaly expression from Table 2 across all configuration elements in the WAN. Most reported issues for this dataset are related to (1) a configuration element missing or (2) present that should not be, or (3) a parameter value from the string templating algorithm being different.

TABLE 4

| Expression | Prefix list | Route policy | Other |
|---|---|---|---|
| present | 92.0 | 90.9 | 38.5 |
| value | 4.2 | 7.3 | 50.6 |
| pow2 | 0.2 | 1.3 | 6.2 |
| integer | 3.6 | 0.1 | 4.0 |
| choice | 0.0 | 0.4 | 0.7 |

Upon examining router community lists, the configuration analyzer 180 discovered inconsistencies in regular expression filters used for matching route communities in configurations. For example, some routers configured a regex starting with a “\hat{ }” character, while most did not. This character, when present, requires a match at the beginning of the border gateway protocol (BGP) community string and may lead to a failed match. Accordingly, the configuration analyzer 180 provides actionable information to address a potential problem.

In another instance, a single router had an IGP routing protocol configuration parameter with a timer value, which had previously caused a widespread outage. When the timer expired, the parameter switched to being “false,” resulting in taking in more traffic than intended. The device did not have the capacity to handle this traffic and it started dropping most of the packets, resulting in connectivity issues. The configuration issue was resolved, but automation later mistakenly reapplied the flawed setting to the configuration file opening up the potential for another major outage. During the testing, the configuration analyzer 180 detected the anomaly before the problem manifested again. Accordingly, such a configuration error can be addressed prior to manifestation of a problem.

### 5G Testbed Example

FIG. 8 is a diagram 800 of another example of configuration analyzer 180 in use for a simplified and anonymized configuration 810 snipped from an operational 5G testbed. The configuration 810 is for a set of radio units (e.g., RU 154), each with around 30 different configuration parameters. These parameters control different aspects of the RU such as the grandmaster PTP IP address, the frequency, the attenuation, and so on. Some of the configuration parameters such as “RRH_RF_GENERAL_CTRL” consist of sequences of hex values. An example template 820 from the configuration analyzer 180 is shown on the right, and the generated anomalous expressions 830 are shown in the bottom left. As an example, the configuration analyzer 180 has identified that the frequency is potentially incorrectly configured for two of the configurations and that the MAC address is potentially wrong for another two.

The string templating algorithm of the template component 182 was evaluated by comparison to a leading data profiling tool that also learns regular expression patterns to represent string sets. Uncached calls made by the configuration analyzer 180 were used to infer string patterns for the WAN configuration datasets and replayed using both the configuration analyzer 180 and the data profiling tool. The performance comparison results are presented in Table 5. The configuration analyzer 180 outperforms the data profiling tool by two to three orders of magnitude in most cases, highlighting its importance as a building block for templating more complex structures.

TABLE 5

| Role | Total calls (K) | | | Mean | | | Median | | | Data Profiling Tool (s) | | | Analyzer (s) | | | Speed up (F/D) | | |
|---|---|---|---|---|---|---|---|---|---|---|---|---|---|---|---|---|---|---|
| R1 | 243 | 871 | 95 | 7.5 | 4.2 | 13.8 | 2 | 3 | 3 | 17855 | 48932 | 7624 | 86 | 53 | 36 | 207x | 923x | 212x |
| R2 | 90 | 395 | 264 | 5.2 | 2.1 | 5.5 | 2 | 2 | 4 | 5864 | 8824 | 74425 | 8 | 11 | 56 | 733x | 802x | 1329x |
| R3 | 164 | 596 | 100 | 8.0 | 2.6 | 13.5 | 2 | 2 | 2 | 11855 | 18356 | 5985 | 54 | 32 | 25 | 220x | 574x | 239x |
| R4 | 96 | 78 | 4 | 2.4 | 2.7 | 16.8 | 2 | 2 | 12 | 2419 | 3015 | 246 | 3 | 1.1 | 0.7 | 806x | 2740x | 351x |
| R5 | 47 | 9 | 0.2 | 2.0 | 2.4 | 4.0 | 2 | 2 | 4 | 1139 | 293 | 10 | 0.4 | 0.2 | 0.2 | 2847x | 1465x | 50x |

The quality of patterns generated by the configuration analyzer 180 was also manually compared to the data profiling tool using a publicly available benchmark dataset for the data profiling tool. The configuration analyzer 180 produced similar patterns as the data profiling tool if given the same regex tokens. The configuration analyzer 180 achieves the capability of data profiling tool to generate multiple patterns for a dataset by adjusting the template threshold described above.

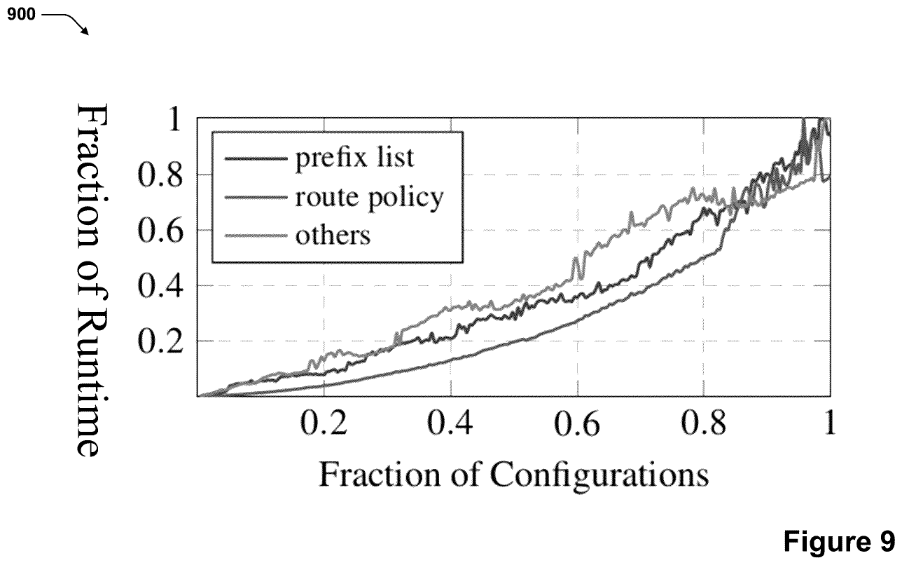

FIG. 9 is a chart 900 showing the fraction of the runtime for the subset of configurations compared to that of the full set of configurations relative to the ratio of configurations analyzed. As discussed above, the configuration analyzer 180 can easily scale to the entire WAN, however, to get a better sense of how the performance varies with the number of configurations, the configuration analyzer 180 was run on smaller subsets of the full set of configurations of the largest role R1 and the relative performance was monitored. The general scaling trend appears close to linear for each type of configuration.

The configuration analyzer 180 offers extensive coverage of configurations due to its compatibility with various nested structures, standard formats such as JSON, XML, and YAML, and ad hoc data formats. For example, the configuration analyzer 180 may handle ACLs, AS Path Lists, Community Lists, DNS Servers, Prefix Lists, Route Policies, Routing Processes, Static Routes, and VRFs. While the data profiling tool supports structured policies like prefix lists and route policies, it requires hand-tuning and implementation for each element type and therefore cannot support many conceptually similar configuration elements like community lists without nontrivial modification. Meanwhile, other tools find anomalies for simple kinds of strings but fail to analyze complex structured configurations.

FIG. 10 is an example snippet of code for an example algorithm 1000 for the template component 182 to efficiently compute the set of matching indices for regular expression tokens against another sequence of characters and tokens. Referring back to the example from FIG. 5, where the input sequence is “1”·[num]·“M” and the goal is to find all sub-strings such that the [num] token necessarily matches that sub-string. For instance, “1” necessarily matches [num], as does “1”·num as well as [num] by itself. However, “1”·[num]·“M”, [num]·“M”, and “M” are not necessarily numbers.

As discussed above, the configuration analyzer 180 takes the sequence “1”·[num]·“M” and starts by mapping each starting index to a set of possible states. Initially, there is only a single possible starting index 0, so the template component 182 starts in the initial state for the automata for [num], resulting in {q₀}→{0}. Now to find what states the finite state machine 512 may be in after consuming the first element of the sequence (“1”), the template component 182 simply applies the automaton transition for “1” for each state, resulting in {q₁}→{0}, which is then stored in the index table 532. Since q1 is an accepting state, this means that the substring from 0 to 0 (i.e., “1”) matches token [num].

Continuing the process, the template component 182 adds {q₀}→{1} alongside the existing {q₁}→{0} to the index table 532 to represent matches starting from the first index as well. At this point, the template component 182 comes across a [num] token in the template sequence. To determine which states the finite state machines 510 can reach by consuming a string that also matches this token, the template component 182 computes the cross product of the token automata with the automata of the [num] token. The starting states are (q₀, q₁) for the old entry ({q₁}→{0}) since the template component 182 has already consumed “1”. The template component 182 needs to find all states that would be final in the first automaton corresponding to a matching string. The template component 182 finds that starting either at index 0 or 1 (same process repeated but with (q₀, q₀) for entry {q₀}→{1}) necessarily results in being in state q₁ only, which means a valid regex match. As a result, the index table 532 for the second entry is updated to {q1}→{0,1} as illustrated in FIG. 5.

Finally, after the last template sequence value “M”, the finite state machine 512 will be in state q2. Once again, the template component 182 adds the entry {q₀}→{2} to the index table 532 before applying the “M” to update the automaton states. For the entry {q₁}→{1,2}, reading “M” results in being in state q2. Similarly, for the new entry {q₀}→{3}, the finite state machine 512 ends up in state q2. Thus the index table 532 is updated to {q2}→{1,2,3} as illustrated in the third entry. This is not a final state, so there is no match for [num] token ending at “M”.

Note that, with this approach, the template component 182 only does work at each step proportional to the number unique sets of automaton states that are reached, which tends to be just a small constant number. The template component 182 also caches the results of the product construction and thus scales nearly linearly with the size of the input strings in practice. The complete algorithm for computing the indices I is shown in FIG. 10.

The FINDMATCHINGSTARTINDICIES (Line 1) takes a regex r and a string template τ as input. The string template (τ=τ₁· . . . ·τₖ) is assumed to be a concatenation of single character const strings and tokens from R. The procedure returns for each index (1≤i≤k), the set of smaller start indices from which the token r matches the sub-template (Iᵢ={j|j≤i∧TOKENMATCH(r, τⱼ· . . . ·τᵢ)}). As described below, the procedure computes these indices using a single linear pass by tracking automaton states. For simplicity, as described above, I may be seen to be returning the last set of indices, I[k], instead of start indices for each i. However, in practice, the template component 182 may compute the starting indices for each ending index for the entire template τ₁· . . . ·τk and cache the result. The template component 182 uses this cache during the dynamic programming step to simply return I [i], when I (r,τ1· . . . ·τi) is called.

The procedure first gets a finite state machine (Aᵣ) from the regular expression input of the token r using a standard GETFSM (Line 2) procedure. The template component 182 takes the alphabet (Σ) of an automaton to be ASCII {char(0), char(1) . . . char(256)} for simplicity, though the implementation of the template component 182 uses Unicode. As the template component 182 considers FSMs, each state in the FSM will have a transition from each symbol in the alphabet. For simplicity, FIG. 10 shows the transitions are stored on a per symbol basis (r), but an actual implementation stores character ranges as shown in finite state machines 510 in FIG. 5.

The matching start indices are maintained using a list of k sets, I (Line 3) and T (Line 4) is the index table described earlier, which is a map from the set of automaton states to the set of start indices. The procedure consumes one element τᵢ at a time and updates/and T (Lines 4 to 9). After the end of the i^{th} iteration, an element (S. V) E T means that the sub-template from any start indices in V to i^{th} index will lead the token automaton to end up in one of the S states. If all the elements until i are const strings, then S will be a singleton since there is always a deterministic path for a const string. However, if some of the elements were tokens, then depending on the token and the transitions in the current automaton Aᵣ, there may be a set of states.

Line 5 accounts for the case where if the template component 182 were to start at the ith index and finish at i^{th} index, then the finite state machine 512 would be in the automaton start state before consuming τᵢ. The procedure calls out UPDATEINDEXTABLE procedure (Line 6) to consume τᵢ and update the index table 532. The UPDATEINDEXTABLE procedure returns a new index table T′ where for each entry (S, V)∈T, there is an entry (S′V)∈T′, which is the result of making a transition on τᵢ from each state in S (Line 14).

The MOVESTATES procedure (Line 17) is split into two cases based on the input τᵢ. If τᵢ is a character, then for each state in the input, the template component 182 gets the next set of states by looking up the transitions in Aᵣ (Lines 37 to 38). If τᵢ is a token, the template component 182 finds all states that could happen from the input set of states if a string is accepted by τᵢ. The template component 182 makes moves in both the automata to calculate the new states. In the Ai, the template component 182 begins in the start state, and in Aᵣ the template component 182 begins in the input set of states (Line 23). The template component 182, makes a transition in both automata for each symbol in the alphabet c as if the input to the automata are single character strings (Line 26), and the template component 182 wants to find out what states that could lead to. If in Ai, that leads to an accepting state, then the single character string is accepted by τᵢ and the set of new states that could happen in Aᵣ is known (Lines 31 to 32). To simulate the two character strings, the template component 182 uses the state combination from the single character string and continues from there (Lines 33 to 35). The template component 182 continues this process until all the combinations are processed, and this process is guaranteed to terminate as each automaton has a finite number of states.

As another example of its generality, the configuration analyzer 180 was utilized to analyze MySQL configurations. The configuration analyzer 180 was compared to an error detection tool for MySQL that identifies Type error by inferring the expected type of each keyword from a training set. The analysis was performed using two sources of configurations: (1) datasets from prior work and (2) public GitHub repositories. The repositories were mined by searching for files with cnf as the file extension and the keyword “innodb” in the file, resulting in approximately 34K configurations of various sizes with many different configuration parameters. The files were filtered using a MySQL configuration syntax validation tool to remove badly written and outdated configuration files, leaving 16K files, which were into JSON format using a simple parser. Since all the files were simple string-based key-value pairs, the configuration analyzer 180 took less than 5 seconds to analyze all 16K files.

The configuration analyzer 180 reports similar number of violations for Type error used in the error detection tool for MySQL. The other classes of errors that the tool reports are fine-tuned for MySQL like integer correlation errors and as such the configuration analyzer 180 does not detect them.

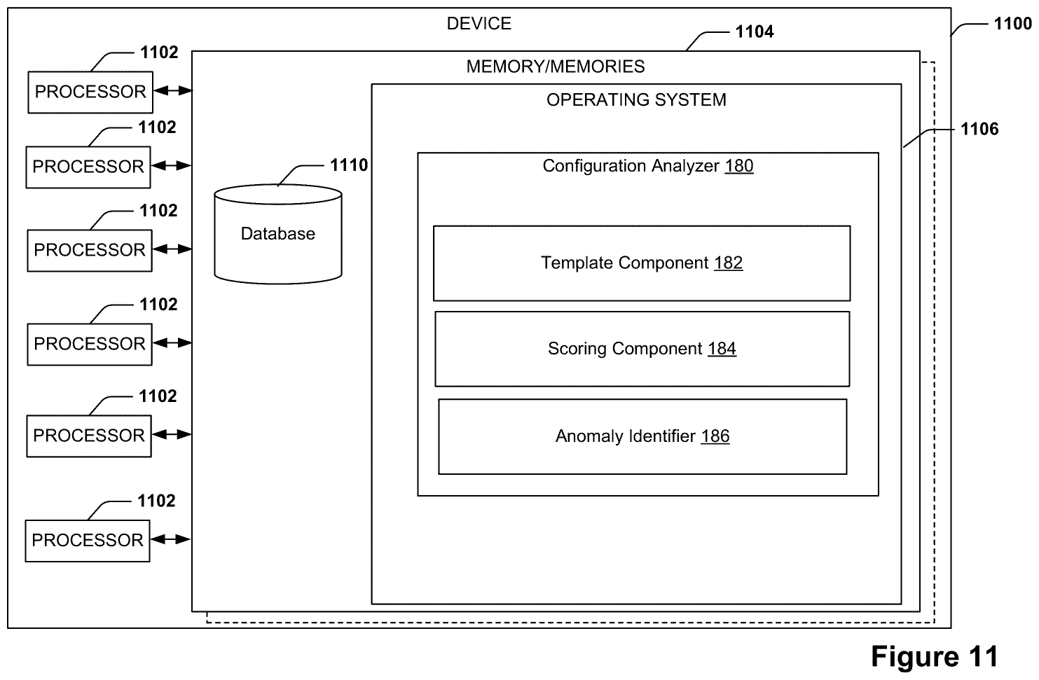

FIG. 11 is a schematic diagram of an example of an apparatus 1100 (e.g., a computing device) for analyzing complex configurations of computer systems or networks. The apparatus 1100 may be implemented as one or more computing devices in the WAN 110.

In an example, the apparatus 1100 includes one or more processors 1102 and a memory/memories 1104 configured to, individually or in combination, execute or store instructions or other parameters related to providing an operating system 1106, which can execute one or more applications or processes, such as, but not limited to, the configuration analyzer 180. For example, processor(s) 1102 and memory/memories 1104 may be separate components communicatively coupled by a bus (e.g., on a motherboard or other portion of a computing device, on an integrated circuit, such as a system on a chip (SoC), etc.), components integrated within one another (e.g., a processor 1102 can include a memory 1104 as an on-board component), and/or the like. Memory/memories 1104 may store instructions, parameters, data structures, etc. for use/execution by processor(s) 1102 to perform functions described herein. In some implementations, the apparatus 1100 is implemented as a distributed processing system, for example, with multiple processors 1102 and memories 1104 distributed across physical systems such as servers or datacenters.

In an example, the configuration analyzer 180 includes template component 182, the scoring component 184 and the anomaly identifier 186. In some implementations, each of the template component 182, scoring component 184, and anomaly identifier 186 are implemented in a distributed manner on different resources of the WAN 110 (e.g., as services or microservices that communicate via an application programming interface). In some implementations, the memory 1104 includes a database 1110 that stores configuration files for different devices.

FIG. 12 is a flow diagram of an example of a method 1200 for analyzing complex configurations of computer systems or networks. For example, the method 1200 can be performed by the configuration analyzer 180, the apparatus 1100 and/or one or more components thereof to analyze a configuration of the WAN 110 or connected networks.

At block 1210, the method 1200 includes inferring a configuration template that is applicable to multiple configuration files. In an example, the configuration analyzer 180 and/or template component 182, e.g., in conjunction with processor 1102, memory 1104, and operating system 1106, can infer a configuration template that is applicable to multiple configuration files. In some implementations, for example, the configuration template includes a concatenation of sub-templates, each sub-template including one or more constant strings, regular expressions, or combinations thereof. In some implementations, at sub-block 1212, the block 1210 may optionally include generating a lowest cost template that is applicable to two of the multiple configuration files based on a cost function. In some implementations, at sub-block 1214, the block 1210 may optionally include combining the lowest cost template with a subsequent configuration file of the multiple configuration files to generate an updated lowest cost template until the updated lowest cost template is applicable to all of the multiple configuration files. For instance, the cost function may assign a per character cost to tokens within the configuration template based on a fit of a regular expression or sub-template to a string of charters of the multiple configuration files. In some implementations, generating the lowest cost template that is applicable to two of the multiple configuration files based on a cost function includes: constructing finite state machines for each token within the configuration template; inferring a cost optimal pattern using a dynamic programming table; and tracking automaton states in separate index tables.

At block 1220, the method 1200 includes using unsupervised learning on the configuration template to score parameters within each configuration file. In an example, the configuration analyzer 180 and/or the scoring component 184, e.g., in conjunction with processor 1102, memory 1104, and operating system 1106, can use unsupervised learning on the configuration template to score parameters within each configuration file. In some implementations, at sub-block 1222, the block 1220 may optionally include mapping each parameter to a numerical value using an expression. In some implementations, at sub-block 1224, the block 1220 may optionally include generating at least one anomaly score for each parameter using an unsupervised learning algorithm.

In some implementations, at sub-block 1226, the block 1220 may optionally include applying an unsupervised learning algorithm across sub-templates within the configuration template to identify anomalous sub-templates and identify parameters matching the anomalous sub-templates as anomalies. In some implementations, at sub-block 1228, the block 1220 may optionally include applying the unsupervised learning algorithm across parameters of the configuration files corresponding to a sub-template of the configuration template to score the parameters individually. In some implementations, the block 1220 may include repeating the mapping using one or more different expressions; and generating an expression-specific score for each parameter using the unsupervised learning algorithm. In some implementations, a final anomaly score for the parameter may be a highest expression-specific score.

At block 1230, the method 1200 includes indicating an anomaly for a parameter of a configuration file exceeding a threshold score. In an example, the configuration analyzer 180 and/or the anomaly identifier 186 e.g., in conjunction with processor 1102, memory 1104, and operating system 1106, can indicate an anomaly for a parameter of a configuration file exceeding a threshold score.

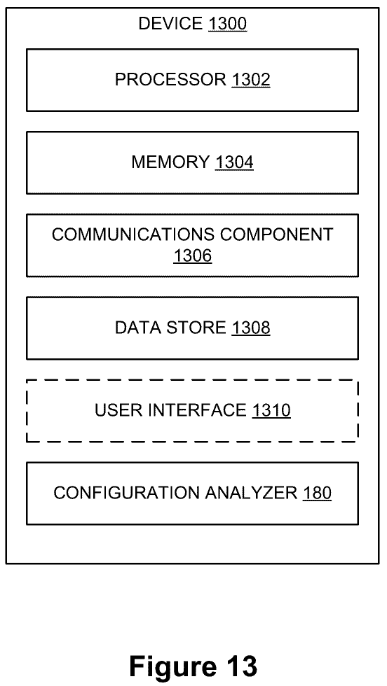

FIG. 13 illustrates an example of a device 1300 including additional optional component details as those shown in FIG. 11. In one aspect, device 1300 includes processor 1302, which may be similar to processor 1102 for carrying out processing functions associated with one or more of components and functions described herein. Processor 1302 can include a single or multiple set of processors or multi-core processors. Moreover, processor 1302 can be implemented as an integrated processing system and/or a distributed processing system.

Device 1300 further includes memory 1304, which may be similar to memory 1104 such as for storing local versions of operating systems (or components thereof) and/or applications being executed by processor 1302, such as the configuration analyzer 180, the template component 182, the scoring component 184, the anomaly identifier 186, etc. Memory 1304 can include a type of memory usable by a computer, such as random access memory (RAM), read only memory (ROM), tapes, magnetic discs, optical discs, volatile memory, non-volatile memory, and any combination thereof.

Further, device 1300 includes a communications component 1306 that provides for establishing and maintaining communications with one or more other devices, parties, entities, etc. utilizing hardware, software, and services as described herein. Communications component 1306 carries communications between components on device 1300, as well as between device 1300 and external devices, such as devices located across a communications network and/or devices serially or locally connected to device 1300. For example, communications component 1306 may include one or more buses, and may further include transmit chain components and receive chain components associated with a wireless or wired transmitter and receiver, respectively, operable for interfacing with external devices.

Additionally, device 1300 may include a data store 1308, which can be any suitable combination of hardware and/or software, that provides for mass storage of information, databases, and programs employed in connection with aspects described herein. For example, data store 1308 may be or may include a data repository for operating systems (or components thereof), applications, related parameters, etc. not currently being executed by processor 1302. In addition, data store 1308 may be a data repository for the configuration analyzer 180.

Device 1300 may optionally include a user interface component 1310 operable to receive inputs from a user of device 1300 and further operable to generate outputs for presentation to the user. User interface component 1310 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 1310 may include one or more output devices, including but not limited to a display, a speaker, a haptic feedback mechanism, a printer, any other mechanism capable of presenting an output to a user, or any combination thereof.

Device 1300 additionally includes the configuration analyzer 180 for analyzing a complex configuration of a computer system or network, a template component 182 for inferring a configuration template that is applicable to multiple configuration files; a scoring component 184 for using unsupervised learning on the configuration template to score parameters within each configuration file; an anomaly identifier 186 for indicating an anomaly for a parameter of a configuration file exceeding a threshold score, etc.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:
Clause 1. An apparatus for analysis of computer configurations, comprising: a memory storing computer-executable instructions; and at least one processor coupled to the memory and configured to execute the instructions to: infer a configuration template that is applicable to multiple configuration files; use unsupervised learning on the configuration template to score parameters within each configuration file; and indicate an anomaly for a parameter of a configuration file exceeding a threshold score.
Clause 2. The apparatus of clause 1, wherein the configuration template comprises a concatenation of sub-templates, each sub-template including one or more constant strings, regular expressions, or combinations thereof.
Clause 3. The apparatus of clause 1 or 2, wherein to infer the configuration template, the one or more processors, individually or in combination, are configured to: generate a lowest cost template that is applicable to two of the multiple configuration files based on a cost function; and combine the lowest cost template with a subsequent configuration file of the multiple configuration files to generate an updated lowest cost template until the updated lowest cost template is applicable to all of the multiple configuration files.
Clause 4. The apparatus of clause 3, wherein the cost function assigns a per character cost to tokens within the configuration template based on a fit of a regular expression or sub-template to a string of charters of the multiple configuration files.
Clause 5. The apparatus of clause 3 or 4, wherein to generate the lowest cost template that is applicable to two of the multiple configuration files based on a cost function, the one or more processors, individually or in combination, are configured to: construct finite state machines for each token within the configuration template; infer a cost optimal pattern using a dynamic programming table; and track automaton states in separate index tables.
Clause 6. The apparatus of any of clauses 1-5, wherein to use unsupervised learning on the configuration template to score parameters within each configuration file, the one or more processors, individually or in combination, are configured to: map each parameter to a numerical value using an expression; and generate an anomaly score for each parameter using an unsupervised learning algorithm.
Clause 7. The apparatus of clause 6, wherein the one or more processors, individually or in combination, are configured to: repeat the mapping using one or more different expressions; and generate an expression-specific score for each parameter using the unsupervised learning algorithm.
Clause 8. The apparatus of any of clauses 1-7, wherein to use unsupervised learning on the configuration template to score parameters within each configuration file, the one or more processors, individually or in combination, are configured to: apply an unsupervised learning algorithm across sub-templates within the configuration template to identify anomalous sub-templates and identify parameters matching the anomalous sub-templates as anomalies; and apply the unsupervised learning algorithm across parameters of the configuration files corresponding to a sub-template of the configuration template to score the parameters individually.
Clause 9. A method of detecting anomalies in configurations of computer systems, comprising: inferring a configuration template that is applicable to multiple configuration files; using unsupervised learning on the configuration template to score parameters within each configuration file; and indicating an anomaly for a parameter of a configuration file exceeding a threshold score.
Clause 10. The method of clause 9, wherein the configuration template comprises a concatenation of sub-templates, each sub-template including one or more constant strings, regular expressions, or combinations thereof.
Clause 11. The method of clause 9 or 10, wherein inferring the configuration template comprises: generating a lowest cost template that is applicable to two of the multiple configuration files based on a cost function; and combining the lowest cost template with a subsequent configuration file of the multiple configuration files to generate an updated lowest cost template until the updated lowest cost template is applicable to all of the multiple configuration files.
Clause 12. The method of clause 11, wherein the cost function assigns a per character cost to tokens within the configuration template based on a fit of a regular expression or sub-template to a string of charters of the multiple configuration files.
Clause 13. The method of clause 11 or 12, wherein generating the lowest cost template that is applicable to two of the multiple configuration files based on a cost function comprises: constructing finite state machines for each token within the configuration template; inferring a cost optimal pattern using a dynamic programming table; and tracking automaton states in separate index tables.
Clause 14. The method of any of clauses 9-13, wherein using unsupervised learning on the configuration template to score parameters within each configuration file comprises: mapping each parameter to a numerical value using an expression; and generating an anomaly score for each parameter using an unsupervised learning algorithm.
Clause 15. The method of clause 14, further comprising: repeating the mapping using one or more different expressions; and generating an expression-specific score for each parameter using the unsupervised learning algorithm.
Clause 16. The method of any of clauses 9-15, wherein using unsupervised learning on the configuration template to score parameters within each configuration file comprises: applying an unsupervised learning algorithm across sub-templates within the configuration template to identify anomalous sub-templates and identify parameters matching the anomalous sub-templates as anomalies; and applying the unsupervised learning algorithm across parameters of the configuration files corresponding to a sub-template of the configuration template to score the parameters individually.
Clause 17. One or more non-transitory computer-readable media storing computer executable instructions for detecting anomalies in configurations of computer systems, the instructions, when executed by one or more processors, individually or in combination, cause the one or more processors to: infer a configuration template that is applicable to multiple configuration files; use unsupervised learning on the configuration template to score parameters within each configuration file; and indicating an anomaly for a parameter of a configuration file exceeding a threshold score.
Clause 18. The one or more non-transitory computer-readable media of clause 17, wherein the configuration template comprises a concatenation of sub-templates, each sub-template including one or more constant strings, regular expressions, or combinations thereof.
Clause 19. The one or more non-transitory computer-readable media of clause 17 or 18, wherein the instructions to infer the configuration template comprise instructions to: generate a lowest cost template that is applicable to two of the multiple configuration files based on a cost function; and combine the lowest cost template with a subsequent configuration file of the multiple configuration files to generate an updated lowest cost template until the updated lowest cost template is applicable to all of the multiple configuration files.
Clause 20. The one or more non-transitory computer-readable media of clause 19, wherein the cost function assigns a per character cost to tokens within the configuration template based on a fit of a regular expression or sub-template to a string of charters of the multiple configuration files.
Clause 21. The one or more non-transitory computer-readable media of clause 19 or 20, wherein the instructions to generate the lowest cost template that is applicable to two of the multiple configuration files based on a cost function comprise instructions to: construct finite state machines for each token within the configuration template; infer a cost optimal pattern using a dynamic programming table; and track automaton states in separate index tables.
Clause 22. The one or more non-transitory computer-readable media of any of clause 17-21, wherein the instructions to use unsupervised learning on the configuration template to score parameters within each configuration file comprise instructions to: map each parameter to a numerical value using an expression; and generate an anomaly score for each parameter using an unsupervised learning algorithm.
Clause 23. The one or more non-transitory computer-readable media of clause 22, further comprising instructions to: repeat the mapping using one or more different expressions; and generate an expression-specific score for each parameter using the unsupervised learning algorithm, wherein a final anomaly score for the parameter is a highest expression-specific score.
Clause 24. The one or more non-transitory computer-readable media of any of clauses 17-23, wherein the instructions to use unsupervised learning on the configuration template to score parameters within each configuration file comprise instructions to: apply an unsupervised learning algorithm across sub-templates within the configuration template to identify anomalous sub-templates and identify parameters matching the anomalous sub-templates as anomalies; and apply the unsupervised learning algorithm across parameters of the configuration files corresponding to a sub-template of the configuration template to score the parameters individually.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus for analysis of computer configurations, comprising:
one or more memories, individually or in combination, storing computer-executable instructions; and
one or more processors coupled to the memory and, individually or in combination, configured to execute the instructions to:
infer a configuration template that is applicable to multiple configuration files;
use unsupervised learning on the configuration template to score parameters within each configuration file; and
indicate an anomaly for a parameter of a configuration file exceeding a threshold score.

2. The apparatus of claim 1, wherein the configuration template comprises a concatenation of sub-templates, each sub-template including one or more constant strings, regular expressions, or combinations thereof.

3. The apparatus of claim 1, wherein to infer the configuration template, the one or more processors, individually or in combination, are configured to:
generate a lowest cost template that is applicable to two of the multiple configuration files based on a cost function; and
combine the lowest cost template with a subsequent configuration file of the multiple configuration files to generate an updated lowest cost template until the updated lowest cost template is applicable to all of the multiple configuration files.

4. The apparatus of claim 3, wherein the cost function assigns a per character cost to tokens within the configuration template based on a fit of a regular expression or sub-template to a string of charters of the multiple configuration files.

5. The apparatus of claim 3, wherein to generate the lowest cost template that is applicable to two of the multiple configuration files based on a cost function, the one or more processors, individually or in combination, are configured to:
construct finite state machines for each token within the configuration template;
infer a cost optimal pattern using a dynamic programming table; and
track automaton states in separate index tables.

6. The apparatus of claim 1, wherein to use unsupervised learning on the configuration template to score parameters within each configuration file, the one or more processors, individually or in combination, are configured to:
map each parameter to a numerical value using an expression; and
generate at least one anomaly score for each parameter using an unsupervised learning algorithm.

7. The apparatus of claim 6, wherein the one or more processors, individually or in combination, are configured to:
repeat the mapping using one or more different expressions; and
generate an expression-specific score for each parameter using the unsupervised learning algorithm.

8. The apparatus of claim 1, wherein to use unsupervised learning on the configuration template to score parameters within each configuration file, the one or more processors, individually or in combination, are configured to:
apply an unsupervised learning algorithm across sub-templates within the configuration template to identify anomalous sub-templates and identify parameters matching the anomalous sub-templates as anomalies; and
apply the unsupervised learning algorithm across parameters of the configuration files corresponding to a sub-template of the configuration template to score the parameters individually.

9. A method of detecting anomalies in configurations of computer systems, comprising:
inferring a configuration template that is applicable to multiple configuration files;
using unsupervised learning on the configuration template to score parameters within each configuration file; and
indicating an anomaly for a parameter of a configuration file exceeding a threshold score.

10. The method of claim 9, wherein the configuration template comprises a concatenation of sub-templates, each sub-template including one or more constant strings, regular expressions, or combinations thereof.

11. The method of claim 9, wherein inferring the configuration template comprises:
generating a lowest cost template that is applicable to two of the multiple configuration files based on a cost function; and
combining the lowest cost template with a subsequent configuration file of the multiple configuration files to generate an updated lowest cost template until the updated lowest cost template is applicable to all of the multiple configuration files.

12. The method of claim 11, wherein the cost function assigns a per character cost to tokens within the configuration template based on a fit of a regular expression or sub-template to a string of charters of the multiple configuration files.

13. The method of claim 11, wherein generating the lowest cost template that is applicable to two of the multiple configuration files based on a cost function comprises:
constructing finite state machines for each token within the configuration template;
inferring a cost optimal pattern using a dynamic programming table; and
tracking automaton states in separate index tables.

14. The method of claim 9, wherein using unsupervised learning on the configuration template to score parameters within each configuration file comprises:
mapping each parameter to a numerical value using an expression; and
generating an anomaly score for each parameter using an unsupervised learning algorithm.

15. The method of claim 14, further comprising:
repeating the mapping using one or more different expressions; and
generating an expression-specific score for each parameter using the unsupervised learning algorithm.

16. The method of claim 9, wherein using unsupervised learning on the configuration template to score parameters within each configuration file comprises:
applying an unsupervised learning algorithm across sub-templates within the configuration template to identify anomalous sub-templates and identify parameters matching the anomalous sub-templates as anomalies; and
applying the unsupervised learning algorithm across parameters of the configuration files corresponding to a sub-template of the configuration template to score the parameters individually.

17. One or more non-transitory computer-readable media storing computer executable instructions for detecting anomalies in configurations of computer systems, the instructions, when executed by one or more processors, individually or in combination, cause the one or more processors to:
infer a configuration template that is applicable to multiple configuration files;
use unsupervised learning on the configuration template to score parameters within each configuration file; and
indicating an anomaly for a parameter of a configuration file exceeding a threshold score.

18. The one or more non-transitory computer-readable media of claim 17, wherein the configuration template comprises a concatenation of sub-templates, each sub-template including one or more constant strings, regular expressions, or combinations thereof.

19. The one or more non-transitory computer-readable media of claim 17, wherein the instructions to infer the configuration template comprise instructions to:
generate a lowest cost template that is applicable to two of the multiple configuration files based on a cost function; and
combine the lowest cost template with a subsequent configuration file of the multiple configuration files to generate an updated lowest cost template until the updated lowest cost template is applicable to all of the multiple configuration files.

20. The one or more non-transitory computer-readable media of claim 19, wherein the cost function assigns a per character cost to tokens within the configuration template based on a fit of a regular expression or sub-template to a string of charters of the multiple configuration files.

21. The one or more non-transitory computer-readable media of claim 19, wherein the instructions to generate the lowest cost template that is applicable to two of the multiple configuration files based on a cost function comprise instructions to:
construct finite state machines for each token within the configuration template;
infer a cost optimal pattern using a dynamic programming table; and
track automaton states in separate index tables.

22. The one or more non-transitory computer-readable media of claim 17, wherein the instructions to use unsupervised learning on the configuration template to score parameters within each configuration file comprise instructions to:
map each parameter to a numerical value using an expression; and
generate an anomaly score for each parameter using an unsupervised learning algorithm.

23. The one or more non-transitory computer-readable media of claim 22, further comprising instructions to:
repeat the mapping using one or more different expressions; and
generate an expression-specific score for each parameter using the unsupervised learning algorithm, wherein a final anomaly score for the parameter is a highest expression-specific score.

24. The one or more non-transitory computer-readable media of claim 17, wherein the instructions to use unsupervised learning on the configuration template to score parameters within each configuration file comprise instructions to:
apply an unsupervised learning algorithm across sub-templates within the configuration template to identify anomalous sub-templates and identify parameters matching the anomalous sub-templates as anomalies; and
apply the unsupervised learning algorithm across parameters of the configuration files corresponding to a sub-template of the configuration template to score the parameters individually.
